(19) United States
(12) Patent Application Publication
(10) Pub. No.: US 2007/0107840 A1
(43) Pub. Date: May 17, 2007

(54) Finishing method for manufacturing wetsuits non-stitch

(75) Inventor: Min-Chen Shiue, I-Lan Hsien (TW)

Correspondence Address: Leonard Tachner;a professional law corporation, Suite 38-E, 17961 Sky Park Circle, Irvine, CA, 92614, US

(73) Assignee: Shei Chung Hsin Ind. Co., Ltd.

(21) Appl. No.: 11/281,118

(22) Filed: Nov. 17, 2005

(51) Int. Cl. B32B 37/00

(52) U.S. Cl. 156/309.6

(57) ABSTRACT

An improved finishing method in the manufacture of wetsuits, can be used in the borders of collars, sleeves, and legs of a wetsuit. The inventive method includes the steps of melding fabric and rubber sponge using pressure and heat to make the fabric and rubber combine completely as one layer. The cutting of the border is neater without being covered with other material. The new method makes the wetsuit more elastic and the wetsuit wearer feels more comfortable.

### BACKGROUND OF THE INVENTION

1. Field of the Invention

The present invention relates to the manufacture of wetsuits and specifically to a finishing method that includes the step of using pressure and heat to combine fabric and rubber into one integral layer of material to obviate the prior art use of additional coverings and stitching.

2. Background Art

The conventional finishing methods used for the borders of collars, sleeves, and legs of a wetsuit are:
1) Raw edge method: No coverings are to be added on the borders. This will usually cause numerous defects such as the cracking of the exposed rubber after a certain time of exposure to sunlight. The fabric part will tear or split, and also cause such edge to become loose after a certain time;
2) Fold-in stitch method: The edge or border is folded inwards and then stitched in place. This finishing method reduces the elasticity of the border due to increased thickness and stitching. Also the friction caused by this fold-in part rubbing the wearer's skin makes the wearer feel uncomfortable;
3) Binding method: A fabric is covered and stitched on the border as a finishing. Such finishing method reduces the elasticity of the border caused by the increase in thickness of the border with added fabric and stitching. The friction caused by this binding method rubbing the wearer's skin makes the wearer feel uncomfortable.

### SUMMARY OF THE INVENTION

A wetsuit is comprised of a layer of rubber sponge laminated with fabric, nylon or polyester, on both sides and the thickness can be adjusted and changeable depending upon demand. The present invention exploits a special quality of this material to meld the fabrics and rubber sponge with pressure and heat to combine the fabric and rubber completely as one layer, the resulting cutting of the border being neat and perfect.

The new method obviates the defects caused by conventional finishing method, fold-in or binding, namely decreased elasticity and discomfort caused by friction. When the new method is applied on the borders of the collar, sleeves, and legs, the elasticity and comfort characteristics of the wetsuit are preserved.

Conventional finishing methods typically reduce the elasticity of the fabric and rubber sponges, even if the fabric or sponge is of high elasticity. The elasticity decrease is caused by the added thickness and the threads used in stitching. The present invention is applied on the borders of the collar, sleeves, and legs, in order to make the fabric and rubber combine completely and allow the finished products to maintain the original elasticity of sponge and fabric without any reduction.

The present invention utilizes the special quality of the rubber and fabric and a pressing machine (mold press) that has powerful pressing ability and instant heat-up and cool-down capability. The wetsuit material is placed on the pressing machine at the area to be processed. Using the mold press, pressure and heat is then applied to the object to be pressed to the required thickness, then instantly cooling it down to fix the object to the required form on the border and to achieve a neat and clean finishing.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIGS. 1 and 2 illustrate the conventional composition of a rubber sponge laminated with fabric, nylon or polyester on both sides and with the raw edge method;

FIGS. 3 and 4 illustrate the conventional fold-in stitch method;

FIGS. 5 and 6 illustrate the conventional binding method;

FIGS. 7-9 illustrate the use of the method of the invention to meld the fabric and rubber sponge with pressure and heat to make the fabric and rubber sponge combine completely as one layer; and

FIGS. 10 and 11 illustrate two alternative ways of carrying out the method of the invention, namely, by flat, in place, pressing (FIG. 10) and by transient rolling (FIG. 11).

### DETAILED DESCRIPTION OF PREFERRED EMBODIMENTS

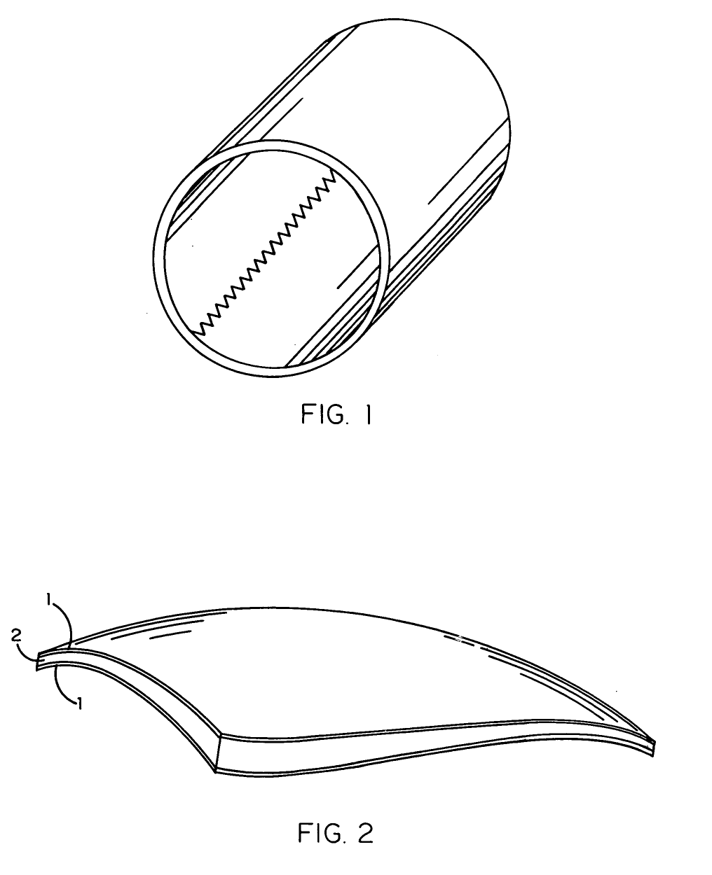

Referring to the accompanying drawings, it will be seen that FIGS. 1 and 2 show a rubber sponge (2) laminated with fabric (1) and (3) on both sides and using a prior art raw edge method.

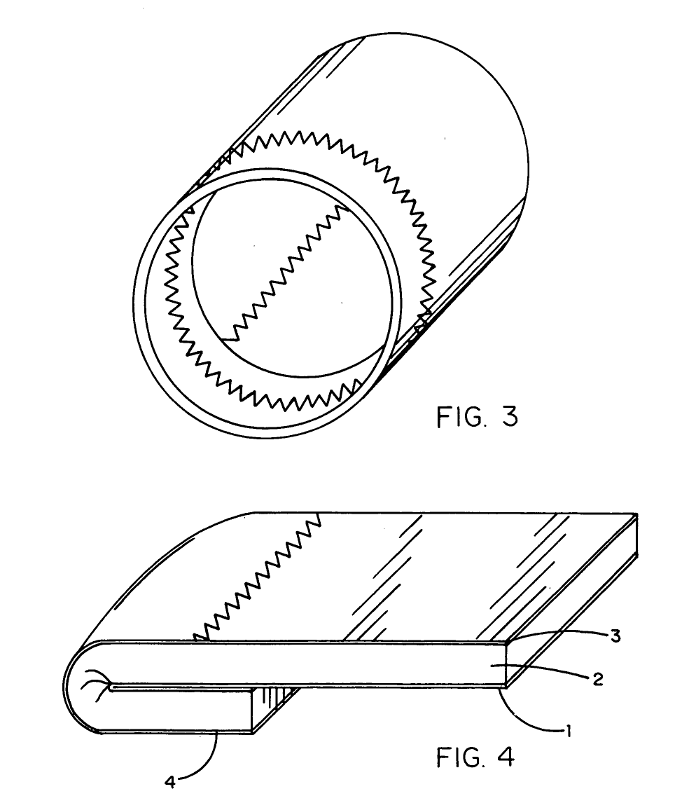

FIGS. 3 and 4 show the conventional fold-in stitch method typically applied to fold the edge (3) into the inner part (1) and stitch (4) to fix the fold in.

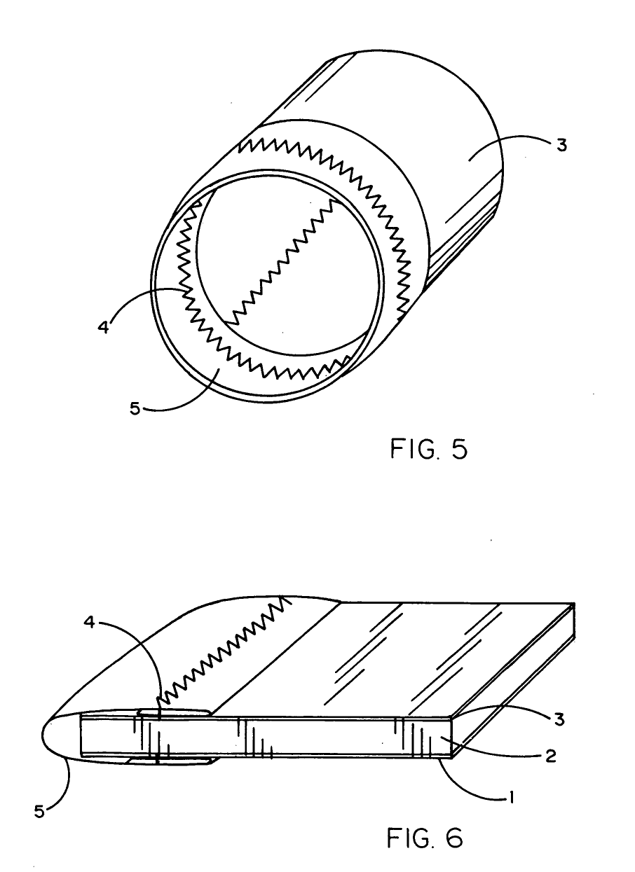

FIGS. 5 and 6 show the conventional binding method typically applied to edging by covering the edge with another fabric (5) and stitch (4) for adhesion.

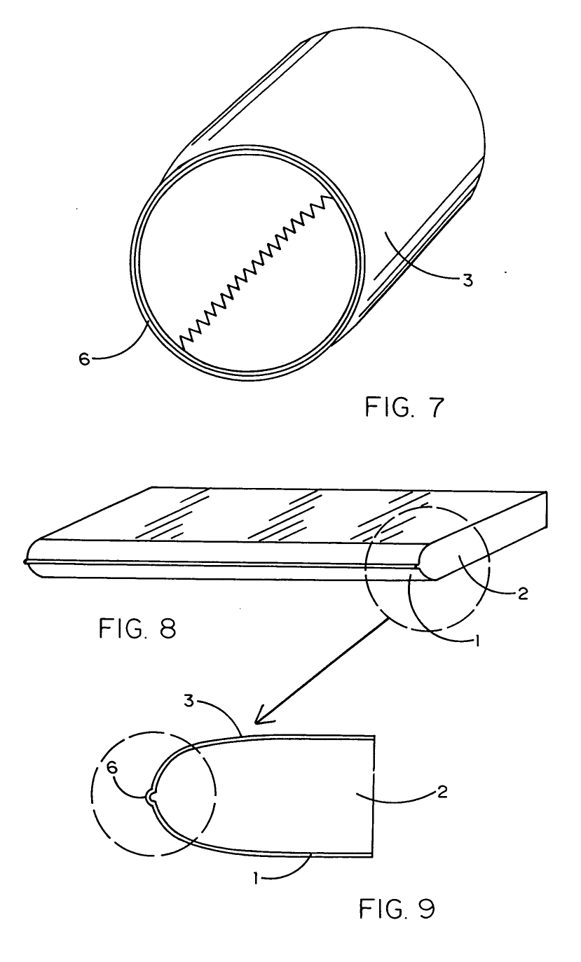

FIGS. 7, 8 and 9 show the present method of the invention which melds the fabrics (1) and (3) and rubber sponge (2) with pressure and heat to make the fabric and rubber sponge combination as thin as one layer and the finishing of the border (6) will be neat without being covered with other materials. As used herein the term “meld” is intended to mean the use of pressure and heat to make the rubber sponge laminated between fabric adhere tightly as one layer, but without actually melting, blending or mixing the different materials.

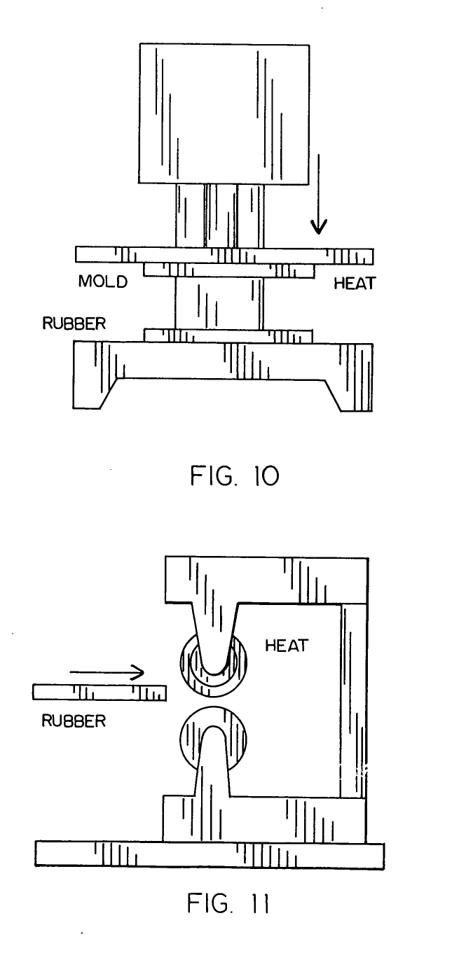

FIGS. 10 and 11 illustrate alternative steps for carrying out the melding method hereof. FIG. 10 illustrates melding by simply pressing the fabric and rubber sponge together while applying heat to the stationary combination. FIG. 11 illustrates melding by rolling the combination of fabric and rubber sponge together under pressure and heat while the combination transitions through the rollers.

As an illustrative example of the present inventive method, a rubber sponge material was sandwiched between opposing layers of fabric forming a total of 0.4 to 1.2 mm thickness. Using a mold press, a pressure of at least 3 kgs/cm² pounds per square inch (psi) was applied for 20 to 40 seconds at peak temperature and then cooled to room temperature within five seconds.

Those having skill in the art of wetsuit manufacture will now, as a result of the above disclosure, perceive various additions and modifications which may be made to the invention while preserving the innovative features thereof. Accordingly, the scope hereof is to be limited only by the appended claims and their equivalents.

We claim:

1. A method for finishing wetsuits at the border areas of collars, sleeves and legs; the method comprising the steps of:
a) forming a wetsuit material by sandwiching a selected thickness of rubber sponge material between opposed layers of selected fabric;
b) applying pressure and heat to the wetsuit material at said border areas to an extent to cause a melding of the rubber sponge and fabric layers into a unitary integral layer while obviating added material and stitching; and
c) cooling said wetsuit material at said melded border areas.

2. The method for finishing recited in claim 1 wherein step b) is carried out using a pressing machine on a stationary wetsuit material.

3. The method for finishing recited in claim 1 where step b) is carried out using a rolling machine on a wetsuit material in motion.

4. The method recited in claim 1 further comprising the step of cutting said melded integral layer to form a desired shape in said border areas.

5. A method for finishing wetsuits at the border areas of collars, sleeves and legs; the method comprising the steps of:
a) forming a wetsuit material by sandwiching a selected thickness of rubber sponge material between opposed layers of an external surface material;
b) applying pressure and heat to the wetsuit material at said border areas to an extent to cause a melding of the rubber sponge and surface material layers into a unitary integral layer while obviating added material and stitching; and
c) cooling said wetsuit material at said melded border areas.

6. The method recited in claim 5 wherein said surface material is taken from the group of materials consisting of fabric, nylon and polyester.
